(19) United States
(12) Patent Application Publication
(10) Pub. No.: US 2006/0112000 A1
(43) Pub. Date: May 25, 2006

(54) Method of trading a financial instrument using stop-order quantity

(76) Inventors: David Ellis, Northfield, IL (US); David Wilkins, Naperville, IL (US)

Correspondence Address: MILTON S. GERSTEIN;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 10/994,918

(22) Filed: Nov. 22, 2004

(51) Int. Cl. G06Q 40/00

(52) U.S. Cl. 705/37

(57) ABSTRACT

A stop quantity order (SQO) on a market-traded instrument for a computerized trading system. An order to buy [sell] instrument X is an SQO if, in addition to a limit price, and a stop price, it also specifies a stop quantity SQ. It is triggered by either of the following two conditions: The market's best offer [bid] price for the instrument is greater [less] than the stop price, or the market's best offer price equals the stop price and the quantity offered [bid] at the best offer [bid] price is less than or equal to the stop quantity. Once triggered, it is submitted to the market as a limit order at the limit price. General stop quantity Orders (GSQO) are similar to SQO's, but use two markets, one as a trigger instrument, and one as a trade instrument. An order to buy [sell] instrument X is a GSQO if it specifies a limit price, stop price, stop quantity SQ, a stop instrument Y, and a stop direction SD (bid or offer). It is triggered by one of the following two conditions: The stop direction is “offer”, [“bid]”, and the market's best offer [bid] price for instrument Y is greater [less] than the stop price, or the quantity offered [bid] at the best offer [bid] price is less than or equal to the stop quantity, and, once triggered, it is submitted to the market as a limit order at the limit price for instrument X.

### BACKGROUND OF THE INVENTION

The present invention is directed to software for use in the trading of financial instruments, and, in particular, in the short-term trading of futures contracts, such as currencies, treasury notes, foreign bonds, and the like, where a trader is in and out of a position within the very same day.

Strategies, tools, and methods of trading financial instruments are numerous and variegated, and software for performing these trading strategies are, also, numerous and variegated. The most typical and conventional strategies relied upon are stop orders and limit orders. A limit order is an order type by which a financial instrument, such as a futures contract, is bought at or below a specified price, or sold at or above a specified price. The specified price is called a limit price. A stop order is a strategy by which a financial instrument is bought at the market price, or offer, when a specified price above the prevailing price at the time the stop order was placed is traded, or is sold at the market price, or bid, when a specified price below the price that prevailed at the time of order is traded. The specified price in this instance is called the stop price.

In the day-trading of futures, such as futures contracts for currencies and treasury notes, an important element in determining when to buy or sell a contract may be based on a continual diminution in the quantity of the orders of the contract being traded on one side of the market in relation to the other side. According to this strategy of trading, when a subjective, predetermined minimum quantity offered or bid of a contract being traded has been reached, such would serve as a trigger or indicator to the trader utilizing this strategy to buy or sell the contract respectively, depending upon the position he or she has taken in the contract, and on the specific characteristics of the futures instrument being traded.

Software applications presently exist for the trader's desktops for placing various types of orders with constraints, such as limit orders, and the like. Example include Trading Technologies' “X_TRADER” electronic trading application, and “X_TRADER” API (application programming interface), which also provide a connection to obtain market prices, working order information, and to route orders to the market place. Other market connectivity products or combinations of products may be used instead. For example, one may use connections directly to electronic exchanges via the individual exchange API, if available, such exchanges being, for example, Eurex, The Chicago Mercantile Exchange, The Chicago Board of Trade, and The London International Financial Futures Exchange (LIFFE).

### SUMMARY OF THE INVENTION

It is the primary objective of the present invention to provide financial-instruments trading software based on a limit-quantity order (LQO), which software uses as one criterion in executing a trade a predetermined minimum quantity setting. Once the quantity offered or bid is below this limit, it is a trigger to buy or sell the financial instrument respectively.

It is, also, the primary objective of the present invention to use limit-quantity order for trading in financial instruments in combination with other, conventional trading techniques, such as limit price.

It is, also, the primary objective of the present invention to use a limit-quantity order for trading in financial instruments where a first financial instrument is bought or sold based on the limit-quantity order of a second financial instrument.

According to the software of the invention, a stop quantity order (SQO) on a market-traded instrument is a limit order triggered by an event. An order to buy [sell] instrument X is an SQO if, in addition to a limit price P, and a stop price SP, it also specifies a stop quantity SQ. It is triggered by either of the following two conditions: The market's best offer [bid] price for X is greater [less] than the stop price, or the market's best offer price equals the stop price and the quantity offered [bid] at the best offer [bid] price is less than or equal to the stop quantity. Once triggered, it is submitted to the market as a limit order at the limit price.

General SQ Orders (GSQO) are similar to SQO'S, but use two markets, one as a trigger instrument, and one as a trade instrument. An order to buy [sell] instrument X is a GSQO if it specifies a limit price P, stop price SP, stop quantity SQ, a stop instrument Y, and a stop direction SD (bid or offer). It is triggered by one of the following two conditions: The stop direction is “offer” [“bid”], and the market's best offer [bid] price for Y is greater [less] than the stop price, or the quantity offered [bid] at the best offer [bid] price is less than or equal to the stop quantity, and, once triggered, it is submitted to the market as a limit order at the limit price.

### BRIEF DESCRIPTION OF THE DRAWINGS

The invention will be more readily understood with reference to the accompanying drawings, wherein:

FIG. 1 is a flow chart of the software of invention showing the use of stop quantity order triggers in the trading of financial instruments for use as a sell trigger;

FIG. 2 is a flow chart of the software of invention showing the use of stop quantity order triggers in the trading of financial instruments for use as a buy trigger;

FIG. 3 is a flow chart of a second embodiment of showing the use of stop quantity order triggers for use in the trading of cross-market financial instruments, where a first financial instrument of a first market is bought based on the stop quantity order trigger of FIGS. 1 or 2 in a second, different financial instrument of a second, different market;

FIG. 4 is an example of a graphical user interface (GUI) use in carrying out the process of FIG. 2; and

FIG. 5 is an example of a graphical user interface (GUI) for use in carrying out the process trade of FIG. 3.

### DETAILED DESCRIPTION OF THE INVENTION

The software of the invention is stored conventionally in computer memory for use by a microprocessor in the conventional manner, and is used as a software module or plug-in inserted into-a conventional traders' desktop-trading applications-that allow the placement of stop orders and limit orders. One example with which the software of the invention may be used is Trading Technologies' “X_TRADER” and “X_TRADER” API, which also provide a connection to obtain market prices, working order information, and to route orders to the market place.

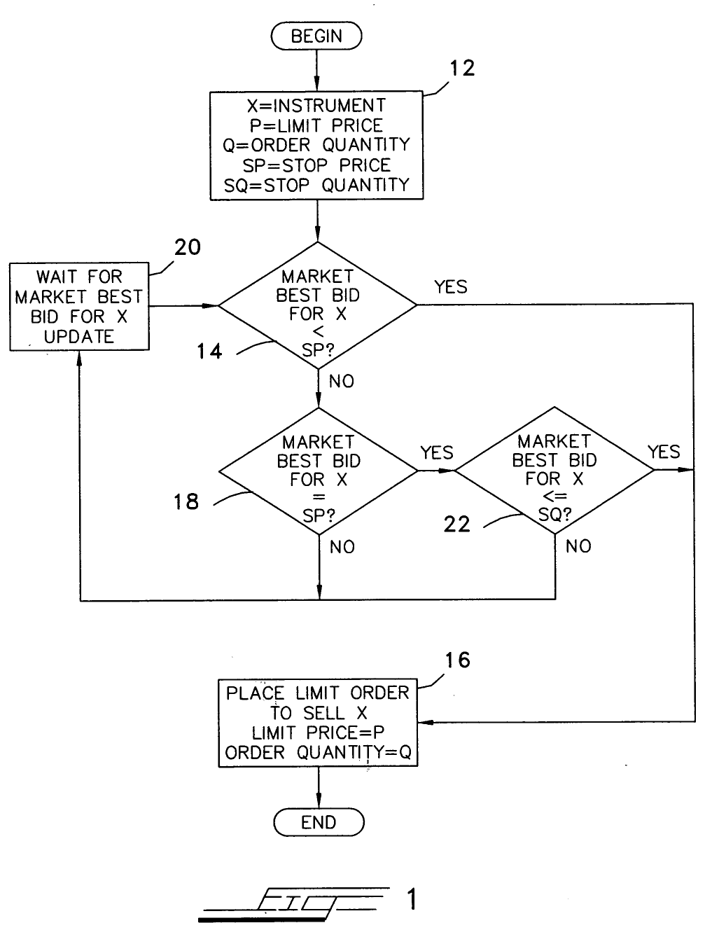

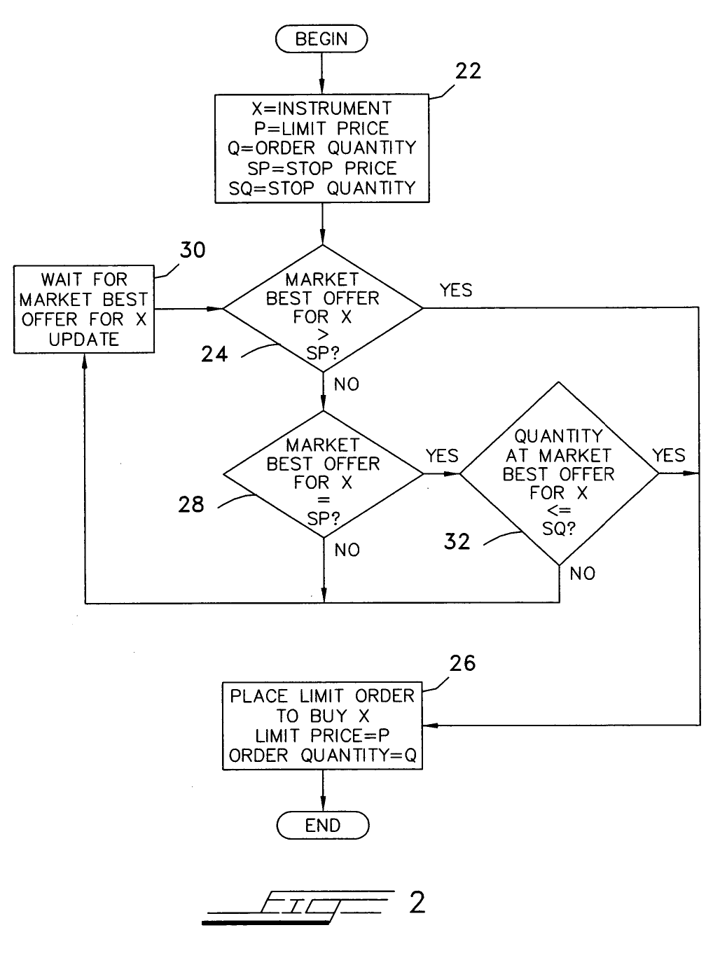

Referring to the drawings in greater detail, there is shown in FIG. 1 a first use of the stop quantity order (SQO) trigger of the software of the invention, for use in triggering a sell-order. This would have special use in the short-term trading of futures contracts, such as futures contracts in treasury notes, currency, foreign national debt instruments such as Bund, and the like, where the trader is typically in and out of the position or transaction the very same day or for just a short time period.

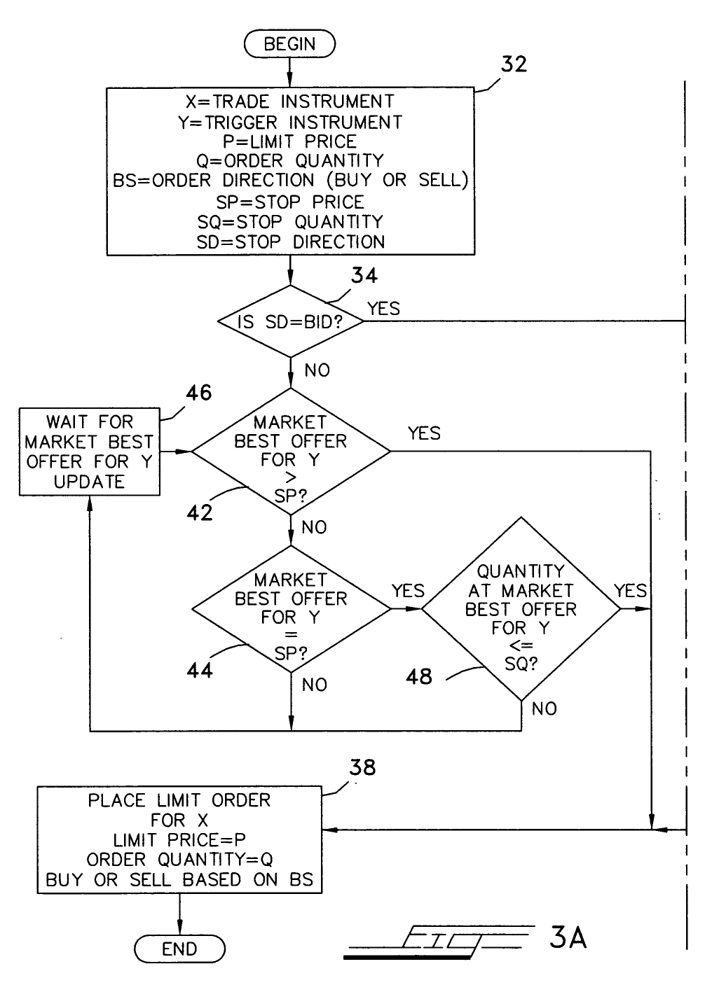

A common sign that a market for a financial instrument is about to move downwardly in price is diminishing quantity at the best bid. In order to aid an investor in determining when to sell that financial instrument of a downwardly-moving market is the stop quantity order trigger of the invention, which trigger will serve as one criterion for executing a trade, and is based on a specific, predetermined, arbitrary minimum value for the quantity associated with the best bid of a specific futures contract, or the like. In FIG. 1, the financial instrument being traded is indicated by an “X”, the trade quantity by “Q”, and the stop quantity trigger of the invention by SQ. SQ is, however, only one trigger used to cause execution of a trade. The other trigger used besides SQ is the stop price SP (block 12). The limit price in this instance is the specified price of a limit order by which a financial instrument is sold at or above a specified bid. The stop price is this instance is the specified price. In many instances of use of the software of the present invention, the stop price SP and the limit price are set equal to each other, as in an example given hereinbelow. Decision block 14 determines if the first trigger-criterion has been met for placing the order. Specifically, decision block 14 determines if the best bid for X is below SP. If “YES”, then the first, associated trigger criteria, the SP associated with the stop order, has been fulfilled, since the market price has dropped to the value below SP. Having satisfied this first stop-order trigger, the software of the invention then places a limit order to sell X at the limit price P for the indicated quantity Q (block 16). If P had been set equal to SP, then the limit order is executed immediately, since P is less than or equal to the best bid of the market. Under these circumstances, SQ is not used as a trigger criterion. If the answer to decision block 14 is “NO”, then the software of the invention determines if the market's best bid price is equal to SP (decision block 18). If “NO”, then the routine returns to wait mode (block 18), continually monitoring the bid price for either a “YES” to decision block 14, upon which the above-described limit order will be placed, or for a “NO” to decision block 14 in combination with a “YES” to decision block 18. When the answer to decision block 18 is “YES”, then the software of the invention then determines if the quantity Q offered at the market's best bid for X is less than or equal to SQ (decision block 22). If “NO”, then the above-described SQO trigger has not been established, returning the subroutine back to its wait mode (block 20). If the answer to decision block 22 is “YES”, meaning that the quantity of X being bid has fallen to or below the stop quantity trigger, then the routine proceeds to block 16 to place the limit order to sell X at the limit price SP for quantity Q, as described above for a “YES” to decision block 14. Thus, it may be seen, that either of two independent triggers serves as a trigger for the placement of the limit order of block 16. The first independent trigger is the stop price SP being greater than the market's best bid; the second, independent trigger is the market's best bid price having fallen to a value equal to the stop price SP but not below it, in combination with the quantity of X being bid having fallen to or below the stop quantity trigger SQ. Either of these two triggers is a sign to serve as an indicator that the market for X is a downwardly-moving one. It is likely that the limit order will be executed to sell X, in anticipation that the market of X will again continue its downward direction. The limit price may be set higher than SP, or be set equal to SP, as the examples given hereinbelow show. The process steps and strategy of FIG. 1 may be used in conjunction with the process steps and strategy of FIG. 2, discussed in detail hereinbelow, in order to determine when to buy X in order to cover the position established during the process steps of FIG. 1 if the limit order of block 16 has been executed.

### Example of Simple Stop Quantity Sell With P Equal To SP

One futures market where the software of the invention has especial relevancy is the Eurodollar contract, which is a short-term interest rate futures contact. As an example as to how the software of the invention discussed with reference to FIG. 1 is used, such will be stated with respect to the Chicago Mercantile Exchange's (CME) Eurodollar contract expiring in June, 2005, for example. If, for example, the market's best bid is 97.37 for 500 contracts and the best offer is 97.375 for 400 contracts, with the tick size for the Eurodollar being 0.005, a trader in these contracts may see the bid quantity at 97.37 drop to 350, then to 200, then to 50, which may precede a movement to a new best bid/offer of 97.365/97.37. As the bid quantity diminishes, a trader may try to take advantage of this movement by short-selling at the bid price of 97.37 in the hope that the market will actually tick down to 97.365/97.37. This is because he will then be short at the market offer and would be situated to liquidate his position without a loss if the downturn did not continue, or to make a profit if downward price pressure continued by buying back the contract at a lower price. The problem hithertofore with executing this strategy is that the movement of the bid quantity size from 500 to 0 can happen too quickly for a trader to react in time. The software of the invention utilizing SQO solves this problem.

Assuming that the trader is of the opinion that if the bid quantity were to drop below 150, there would be a very good chance that the market will tick down to 97.365/97.37, whereupon he would like to take advantage of this situation by selling 10 contracts at the bid (97.37). He may, therefore, place a stop quantity order (SQO) of the invention with the following parameters:
X=the June 2005 Eurodollar contract
P=97.37 (he will receive this for the sell)
Q=10 (he will sell 10 contracts)
SP=97.37 (the price level he is using for a trigger—in this case, the best bid)
SQ=150 (the size below which the market must drop at 97.37 in order to trigger his order).

The following are the possibilities of what may occur. If the bid size eventually drops to 50 as described above, the stop quantity order (SQO) is triggered and a limit order to sell 10 contracts of X at 97.37 is placed. If, by the time the exchange receives this order, the bid is still valid, the order will be immediately executed and the trader's order is filled at 97.37. If, instead, the quantity of 500 on the bid disappears so rapidly that the bid itself falls to 97.365, the order is also triggered as a limit order to sell 10 contracts of X at 97.37 and the trader has “joined” the new offer at 97.37.

It may, however, occur that the offer size does not move to 150 or below, or the market rises to 97.375/97.38. In this case, the stop quantity order remains in force, but is not triggered.

### Example of Simple Stop Quantity Sell With P Not Equal To SP

Continuing with the above example, it may be that the 97.37 price represents a crucial price level to the trader, or to the market, with the trader willing to “sell down” beyond the 97.37 level if the quantity on the bid falls to 150 or below. In other words, if the bid quantity falls to 150 or below, the trader wants a better chance of his order being filled immediately rather than joining the new offer if the market should tick down. If he is willing to “reach” down to 97.35 in this case, he would place the same order as above, except that he would specify a limit price of 97.35 instead of 97.37. In this case, the order would still be triggered based on the stop price of 97.37, but the triggered order's limit price would be different. The following is how the three scenarios given hereinabove would look in this instance. If the bid size eventually drops to 50 as described above, the stop quantity order is triggered, and a limit order to sell 10 contracts of X at 97.35, and not 97.37, is placed. If, by the time the exchange receives this order, the bid is still valid, the order will be immediately executed and the trader's order is filled at this 97.37. If, instead, the quantity of 500 on the bid disappears so rapidly that the bid itself falls to 97.365, the order is also triggered as a limit order to sell 10 contracts of X at 97.35 and the trade will be filled at 97.365. It may be that the bid size does not move to 150 or below, or that the market rises to 97.375/97.38. In this case, the stop quantity order remains in force, but is not triggered.

Referring now to FIG. 2, there is shown a similar routine but for use in determining when to buy a financial instrument X. A commonly-used sign that the market is about to move upwardly is a diminishing quantity at the best offer. The trading strategy used in determining when to buy utilizes the same variables as that of FIG. 1. In FIG. 2, the financial instrument being traded is indicated by an “X”, its volume by a “Q”, and the stop quantity trigger by SQ. However, as in FIG. 1, SQ is only one trigger used to cause execution of a trade. The other trigger used besides SQ is the stop price SP (block 22). The limit price in this instance is the specified price of a limit order by which a financial instrument is bought at or below that specified price. The stop price is this instance is the specified price. The routine of FIG. 2 first determines if the primary trigger has been met, which is the market's best offer being greater than SP. If “YES”, then the buy limit order is automatically placed (block 26), bypassing any need for other triggers such as SQ, similarly to what was discussed above with reference to FIG. 1. The market price having surpassed SP is used as an indication of a market going up in price. The limit order serves as a conservative technique for this assumption, with P being set equal to SP or different therefrom. If the answer to decision block 24 is “NO”, then the routine checks for the next trigger criterion. In decision block 28, the software determines if the market's best offer for X is equal to the stop price SP. If “NO”, suggesting no trigger criterion for indicating a buy signal has been generated, the routine returns to a wait-mode (block 30), awaiting either a “YES” to decision block 24 or a “NO” to decision block 24 in combination with a “YES to decision block 28. If the answer to decision block 28 is “YES”, then the software checks to see if the quantity offered for X at the market's best offer is less than or equal to SQ(decision block 32). If “NO”, indicating again no specific trigger-criterion has been generated for indicating a buy signal, the routine to returns to block 30 to be in its wait-made. If the answer to decision block 32 is “YES”, meaning the second trigger-criterion has been generated, the software places the limit order to buy X at P with quantity Q (block 26). This strategy to buy X assumes that a temporary market uptick or upturn is about to occur, either because the market price has surged above a predetermined value (SP), such as a statistical moving average used by chartists, or the like. If such predetermined value (SP) has been exactly reached, one assumes that there is still an uptrend in the market, but without additional criterion one would not buy. Above-discussed SQ in decision block 32 is used as the additional trigger to buy. SQ is used in this buy-mode to indicate that, although there is an assumption that the market price for X is in an uptrend, the presence of SQ Below are examples of the use of this buy strategy utilizing the same financial instrument given in the sell-examples hereinabove, where P is set equal to SP.

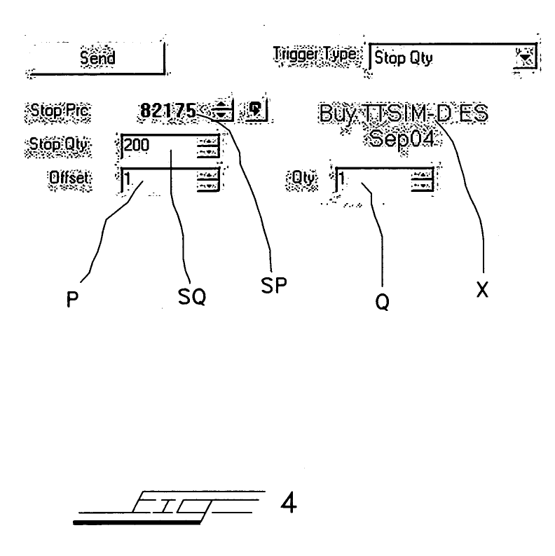

An example of a graphical user interface (GUI) used in the SQO of FIG. 2, for placing the limit order of block 26 of FIG. 2, is shown in FIG. 4., and shows the arrangement of the variables P, X, SP, Q, and SQ of the invention.

### Example of Simple Stop Quantity Buy With P Equal To SP

A trader may see the offer quantity at 97.375 drop to 350, then to 200, and then to 50, preceding a movement to a new best bid/offer of 97.375/97.38. As the offer quantity diminishes, a trader will try to take advantage of this movement by buying at the offer price of 97.375 in the hope that the market will actually tick up to 97.375/97.38. This is because he will then be long at the market bid and would be situated to liquidate his position without a loss if the rally did not continue or to make a profit, if upward price pressure continued. The problem with executing this strategy is that the movement of the offer size from 400 to 0 can happen too quickly for a trader to react. The SQO of the present solves this problem. Assuming that the trader is of the opinion that, if the offer quantity were to drop below 150, there would be a very good chance that the market will tick up to 97.375/97.38, and would like to take advantage of this situation by buying 10 contracts at the offer (97.375). He could place a stop quantity order with the following parameters:
X=the June 2005 Eurodollar contract
P=97.375 (he will pay this for the buy)
Q=10 (he will buy 10 contracts)
SP=97.375 (the price level he is using for a trigger—in this case, the best offer)
SQ=150 (the size below which the market must drop at 97.375 in order to trigger his order).

The following different scenarios may occur. If the offer size eventually drops to 50 as described above, the stop quantity order of the invention is triggered, and a limit order to buy 10 contracts of X at 97.375 is placed. If, by the time the exchange receives this order, the offer is still valid, the order will be immediately executed and the trader's order is filled at 97.375. If, instead, the quantity of 400 on the offer disappears so rapidly that the offer itself jumps up to 97.38, the order is also triggered as a limit order to buy 10 contracts of X at 97.375 and the trader has “joined” the new bid at 97.375. It may be, however, that the offer size does not move to 150 or below, or that the market dips to 97.365/97.37. In this case, the stop quantity order remains in force, but is not triggered.

### Example of Simple Stop Quantity Buy With P Not Equal To SP

Continuing with the above example, it may be that the 97.375 price represents a crucial price level to the trader or to the market, whereupon the trader is willing to “pay up” beyond the 97.375 level if the quantity on the offer falls to 150 or below. In other words, if the offer quantity falls to 150 or below, the trader wants a better chance of his order being filled immediately rather than joining the new bid if the market should tick up. If he is willing to “reach” up to 97.4 in this case, he will place the same order as above, except that he would specify a limit price of 97.4 instead of 93.375. In this case, the order would still be triggered based on the stop price of 97.375, but the triggered order's limit price would be different. The following three scenarios could occur in this instance. If the offer size eventually drops to 50 as described above, the stop quantity order is triggered and a limit order to buy 10 contracts of X at 97.4 is placed. If, by the time the exchange receives this order, the offer is still valid, the order will be immediately executed and the trader's order is filled at 97.375. If, instead, the quantity of 400 on the offer disappears so rapidly that the offer itself jumps up to 97.38, the order is also triggered as a limit order to buy 10 contracts of X at 97.4 and the trade will be filled at 97.38. It may be, however, that the offer size does not move to 150 or below, or that the market dips to 97.365/97.37. In this case, the stop quantity order remains in force, but is not triggered.

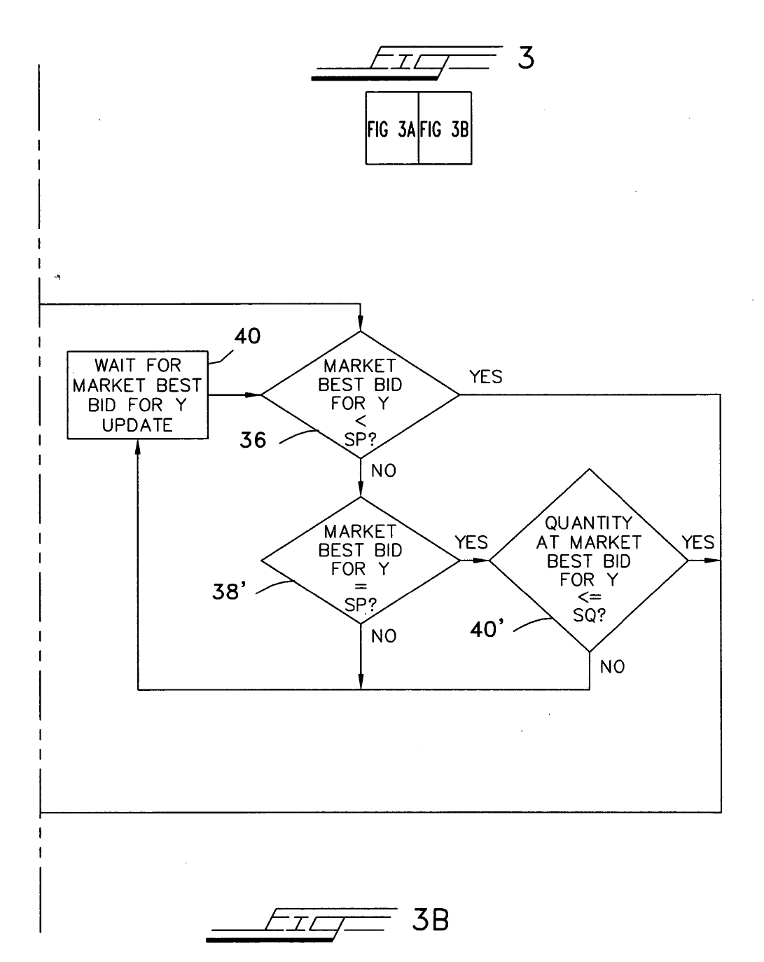

Referring now to FIG. 3, there is shown the flow chart for the software of the invention for a cross-market stop-quantity order, or general stop quantity order (GSQO), where two different markets are employed, one market trading an instrument that is to be used as a trigger instrument, and the other market trading an instrument that is to be used as the trade instrument: To wit, the actual instrument that will be bought or sold based on the movement of the instrument of the other market. The two markets are those that have shown to be historically or intuitively linked to one degree or another, such that movement in one market may serve as an indicator in its linked market. Movement in one direction or the other in the one market may indicate a like or opposite movement in the linked market. In FIG. 3, the variables considered are as follows: the first, or trade, instrument X in a first market that is to be traded; a second, or trigger, instrument Y that is traded in a second, different market; order quantity Q of the trade instrument X; limit price P of the traded instrument X; order direction BS of the first instrument, if it is a buy or sell order; the stop price SP for trigger instrument Y; the stop quantity trigger SQ for trigger instrument Y; and stop direction SD of the second trigger instrument Y (block 32). The software of the invention first determines if the stop direction of the market for trigger instrument Y is bid or offer. If bid (“YES” to decision block 34), then the software determines if the market's best bid for trigger instrument Y is less than the stop price SP (decision block 36), which is similar to the trigger process of FIG. 1 with the trigger data coming from the second trigger instrument Y instead of the traded instrument X. If the market's best bid for Y is less than SP, then the routine proceeds to place a limit order for instrument X at P with quantity Q, with the order direction BS being either buy or sell (block 38) depending upon the actual or perceived correlation between the trigger instrument and the trade instrument Y as determined by the trader himself. If, however, the market's best offer for Y is not less than SP (“NO” to decision block 36), then the routine will check to see if the best offer is equal to SP (decision block 38). If “NO”, the routine returns to wait-mode (block 40) to await a trigger. If the best bid is equal to SP (“YES” to decision bock 38), then the routine checks for the SQ parameter of the invention for instrument Y (decision block 40). If the quantity at the best bid for instrument Y is not less than or equal to the trigger quantity SQ, the routine returns to its wait-mode (block 40) to await a trigger. If, however, SQ is satisfied in decision block 40, the limit order of block 38 is placed, as discussed hereinabove.

If in decision block 34 the answer is “NO”, indicating SD is an offer, then the software determines in decision block 42 if the market's best offer for instrument Y is greater than the stop price SP set for Y. If “YES”, then the limit order of block 38 is immediately placed as discussed hereinabove, with BS being a sell or buy, again depending upon whether there is a perceived direct or inverse correlation of the instruments X and Y. If the answer to decision block 42 is “NO”, then the routine checks to see if the best offer is equal to SP for Y (decision block 44). If “NO”, then the routine returns to its wait-mode (block 46). If the best offer is equal to SP (“YES” to decision block 44), then the routine checks the SQ trigger of the invention in decision block 48. If the SQ is not met (“NO” to decision block 48), then the routine returns to the wait-mode (block 46). If the SQ trigger has been met, with the quantity of the best offer for instrument Y being equal to or less than SQ (“YES” to decision block 48), the limit order of block 38 is immediately placed.

Hereinbelow are examples of the use of this general stop quantity order (GSQO) of the invention for SD being a bid and for SD being an offer, which examples expound upon the examples given above where the trade instrument is CME's Eurodollar contract expiring in June, 2005, for example.

### Generalized Stop Quantity Buy Example

In addition to the Eurodollar market example discussed hereinabove, if a trader recognizes that the Eurodollar contract reacts to changes in the market for another product, such as, for example, the e-mini S&P 500 futures contract of December 2004 traded on the Chicago Mercantile Exchange, he will then surmise that the Eurodollar contract will rally if the e-mini S&P 500 futures breaks below a critical price level, such as 956.5, for example. Further, supposing that the e-mini market is 956.5/956.75, with the tick size in this market being 0.25, with 750 contracts on the bid side, a trader does not want to wait for the price of the e-mini to actually drop below the 956.5 mark, because he suspects that everyone is waiting for this, and it will be unlikely that he will be able to react in time to buy the Eurodollars at a good price. He would like to use the same principle given hereinabove to trigger his buy order on the Eurodollar, the trade instrument. Namely, if the bid size on the e-minis (trigger instrument) drops below 300, then it is very likely that the e-mini market is about to down-tick to 956.25/956.5. Therefore, he would like to buy the Eurodollars when the bid size on the e-minis drops below 300 or the bid price drops below 956.5. To do this, he places a GSQO with the following parameters:
X=June 2005 Eurodollar
Y=December 2004 e-mini S&P
P=37.375 (limit price for the Eurodollar buy)
Q=10 (amount of Eurodollars to buy)
BS=Buy (he is buying Eurodollars)
SP=956.5 (triggered by the quantity at 956.5)
SQ=300 (triggered at a bid size of 300 or below)
SD=Bid (the trigger is monitoring the bid side of the e-mini markets).

In this case, the order is triggered if the bid quantity is 300 or less for a best bid of 956.5 in the e-minis or if the e-mini best bid falls below 956.5. The triggering of the order results in the submission of a buy order for 10 Jun. 2005 Eurodollar contracts at a limit price of 97.375.

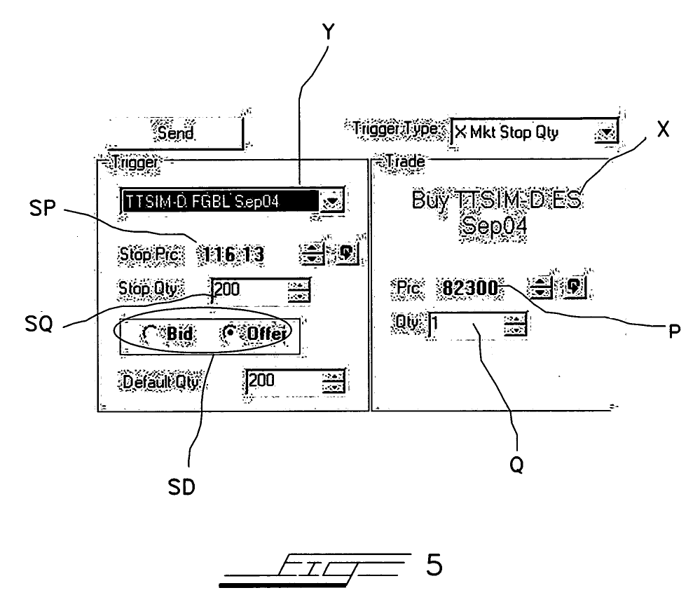

An example of a graphical user interface (GUI) for use in carrying out the GSQO of FIG. 3, is shown in FIG. 5, which GUI is used for placing the limit order for trade instrument X in block 38 of FIG. 3, and shows the arrangement of the variables SD, SQ, SP, Q, P, Y, and X.

### Generalized Stop Quantity Sell Example

In addition to the above Eurodollar market, assume that the trader recognizes that the Eurodollar contract reacts to changes in the market for another product, such as, for example, the e-mini S&P contract of December 2004. He surmises that the Eurodollar contract will fall if the e-mini rises above a critical price level (say 956.75). Further, supposing that the e-mini market is 956.5/956.75 with 750 contracts on the offer, a trader does not want to wait for the price of the e-mini to actually rise above the 956.75 mark, because he suspects that everyone is waiting for this and it will be unlikely that he will be able to react in time to sell the Eurodollars at a good price. He would like to use the same principle as above to trigger his sell order on the Eurodollar. Namely, he thinks that if the offer size on the e-minis drops below 300, then it is very likely that the e-mini market is about to up tick to 956.75/957. So, he would like to sell the Eurodollars when the offer size on the e-minis drops below 300 or the offer price rises above 956.75. To do this, he places a stop quantity order GSQO with the following parameters:
X=June 2005 Eurodollar
Y=December 2004 e-mini S&P
P=37.37 (limit price for the Eurodollar sell)
Q=10 (amount of Eurodollars to sell)
BS=Sell (he is selling Eurodollars)
SP=956.75 (triggered by the quantity at 956.75)
SQ=300 (triggered at a offer size of 300 or below)
SD=Offer (the trigger is monitoring the offer side of the e-mini markets).

In this case, the order is triggered if the offer quantity is 300 or less for a best offer of 956.75 in the e-minis or if the e-mini best offer rises above 956.75. The triggering of the order results in the submission of a sell order for 10 Jun. 2005 Eurodollar contracts at a limit price of 97.37.

The following is the C# software code listing for the embodiment of FIGS. 1 and 2 for the singe financial instrument.

```
// Method to check if order is triggered
public override OrderTrigger.STATUS Check(DEInstrument instrument,
ref string msg)
{
    // Test determined if this is a buy or a sell
    if(this.IsBuy)
    {
        // This is a buy order, so we are waiting on an offer qty
        // If the market offer has risen above the stop price
        if(instrument.AskPrice > this.StopPrice)
        {
            // The offer has risen above the stop price - send it
            msg = “Buy triggered with ask = “ + instrument.AskStr
                + ” and stopPrice = ” + this.StopPriceStr;
            // Return a send request
            return OrderTrigger.STATUS.SEND;
        }
        // If the best offer equals the stop price and the offer
        // quantity is at or below the stop quantity
        if(instrument.Ask == this.StopPrice && this.StopQty >=
        instrument.AskQty)
        {
            // The offer is at the stopPrice and the qty is below stop qty
            // Send it
            msg = “Buy triggered with ask = “ + instrument.AskStr;
            msg += ” and qty = ” + instrument.AskQtyStr;
            // return a request to send
            return OrderTrigger.STATUS.SEND;
        }
        // Conditions not met, wait for market update
        return OrderTrigger.STATUS.HOLD;
    }
    else // This is a sell
    {
        // This is a sell order, so we are waiting on a bid qty
        // If the best bid is below the stop price
        if(instrument.Bid < this.StopPrice)
        {
            // The bid has dropped below the stop price - send it
            msg = “Sell triggered with bid = “ + instrument.BidStr
                + ” and stopPrice = ” + this.StopPriceStr;
            // return send request
            return OrderTrigger.STATUS.SEND;
        }
        // If the bid is at the stop price and the bid quantity is
        // at or below the stop quantity
        if(instrument.Bid == this.StopPrice && this.StopQty >=
        instrument.BidQty)
        {
            // The bid is at the stop price and the qty is below stop qty
            // Send it
            msg = “Sell triggered with bid = “ + instrument.BidStr;
            msg += ” and qty = ” + instrument.BidQtyStr;
            // return send request
            return OrderTrigger.STATUS.SEND;
        }
        // Conditions not met, wait for next market update
        return OrderTrigger.STATUS.HOLD;
    }
}
                COPYRIGHT - DE Trading Corporation - 2004.
```

The following is the C# software code listing for the embodiment of FIG. 3 for the dual financial instruments with one being a trigger instrument and the other the trade instrument.

```
// Method to check if order is triggered
    public override OrderTrigger.STATUS Check(DEInstrument instrument,
                                ref string msg)
    {
        if(!rep.BidTriggered) // Is the stop direction = “Bid”?
        {
            // No, the stop direction is “Offer”
            // This is an offer trigger, so we are waiting on an offer qty
            // If the best offer is above the stop price
            if(instrument.Ask > this.rep.StopPrice)
            {
                // The offer has risen above the stop price - send it
                msg = “Order triggered with ask = “
                + instrument.AskStr
                + ” and stopPrice = ” + this.StopPriceStr;
                // Return a send request
                return OrderTrigger.STATUS.SEND;
            }
            // If the stop price = the best offer and the offer qty <= stop quantity
            if(instrument.Ask == this.rep.StopPrice && this.rep.StopQty >= instrument.AskQty)
                {
                // The offer is at the stopPrice and the qty is below stop qty
                    // Send it
                    msg = “Order triggered with ask = “
                        + instrument.AskStr;
                    msg += ” and qty = ” + instrument.AskQtyStr;
                    // return send request
                    return OrderTrigger.STATUS.SEND;
                }
                // Conditions for sending have not been met wait for another update
                return OrderTrigger.STATUS.HOLD;
            }
            else // In this case, the stop direction is “Bid”
            {
                // This is a bid order, so we are waiting on a bid qty
                // If the bid is below the stop price
                if(instrument.Bid < this.rep.StopPrice)
                {
                    // The bid has dropped below the stop price - send it
                    msg = “Order triggered with bid = “
                    + instrument.BisStr + ” and stopPrice = ”
                    + this.StopPriceStr;
                    // return send request
                    return OrderTrigger.STATUS.SEND;
                }
                // If the bid is at the stop price and the bid qty is at or below the stop qty
                if(instrument.Bid == this.rep.StopPrice && this.rep.StopQty >= instrument.BidQty)
                {
                    // The bid is at the stop price and the qty is below stop qty
                    // Send it
                    msg = “Order triggered with bid = “ +
                        instrument.BidStr;
                    msg += ” and qty = ” + instrument.BidQtyStr;
                    return OrderTrigger.STATUS.SEND;
                }
                return OrderTrigger.STATUS.HOLD;
            }
        }
                            COPYRIGHT - DE Trading Corporation - 2004.
```

While specific embodiments of the invention have been shown and described, it is to be understood that numerous changes and modifications may be made therein without departing from the scope and spirit of the invention.

What is claimed is:

1. In a computerized trading system for use by traders comprising a microprocessor memory storage means, and applications software stored by said memory storage means for execution by said microprocessor; said applications software comprising first means for retrieving market data from a market for obtaining the market price, bid quantity, and offer quantity of a traded instrument for use by a trader in determining buy and sell orders in said traded instrument, second means for providing specified input data about price and trade quantity of one of a buy limit order and a sell limit for the traded instrument, and third means for transmitting the one buy limit order and sell limit order to said market for executing said order based on said specified input data; the improvement comprising:
said second means providing limit price and stop price criteria upon which said one limit order is based, and providing a stop quantity order trigger for said one limit order, said stop quantity order trigger defining a minimum quantity below which and at which said one limit order is submitted, and above which said market order is pending;
said minimum quantity being a trigger limit for submitting said one limit order;
whereby when said one of the market bid quantity or market offer quantity of the traded instrument is one of equal to and less than said specified minimum quantity, said one limit order is submitted to said market for execution.

2. The computerized trading system for use by traders according to claim 1, wherein said market is one for futures contracts; said market order being a short-term order executed and closed out the same day.

3. The computerized trading system for use by traders according to claim 1, wherein said one order is a pending sell limit order when said market's best bid price is equal to said stop price and said stop quantity order trigger is less than said market's bid quantity at said market's best bid price.

4. The computerized trading system for use by traders according to claim 1, wherein said one order is a submitted sell limit order when said market's best bid price is equal to said stop price and said stop quantity order trigger is greater than or equal to said market's bid quantity at said market's best bid price.

5. The computerized trading system for use by traders according to claim 1, wherein said one order is a pending sell limit order when said market's best bid price is greater than said stop price.

6. The computerized trading system for use by traders according to claim 1, wherein said one order is a submitted limit order when said market's best bid price is less than said stop price.

7. The computerized trading system for use by traders according to claim 1, wherein said one order is a submitted buy limit order when said market's best offer price is equal to said stop price and said stop quantity order trigger is greater than or equal to said market's offer quantity at said market's best offer price.

8. The computerized trading system for use by traders according to claim 1, wherein said one order is a pending buy limit order when said market's best offer price is equal to said stop price and said stop quantity order trigger is less than said market's offer quantity at said market's best bid price.

9. The computerized trading system for use by traders according to claim 1, wherein said one order is a pending buy limit order when said market's best offer price is less than said stop price.

10. The computerized trading system for use by traders according to claim 1, wherein said one order is a submitted buy limit order when said market's best offer price is greater than said stop price.

11. In a computerized trading system for use by traders comprising a microprocessor memory storage means, and applications software stored by said memory storage means for execution by said microprocessor; said applications software comprising first means for retrieving market data from a plurality of markets for obtaining market price, bid quantity, and offer quantity of a first market for a first traded instrument, and market price, bid quantity, and offer quantity of a second market for a second instrument for use by a trader in determining buy and sell orders, second means for providing specified input data about price and trade quantity of one of a buy limit order and a sell limit order for a traded instrument, and third means for transmitting the one buy limit order and sell limit order to a market for submitting said one order based on said specified data; said second means also providing limit price and stop price criteria upon which said one limit order is based, the improvement comprising:
said second means comprising first order-input means for the limit price, order quantity and type of limit order for said first traded instrument of said first market;
said second means comprising second trigger-input means for stop price, stop direction, and stop quantity of said second traded instrument of said second market;
said second means providing a stop quantity order trigger for said first trade instrument of said first market, said stop quantity order trigger defining a minimum quantity in said second market below which and at which said one limit order for said first trade instrument in said first market is submitted, and above which said market order is pending;
said stop price and said stop direction for said stop price of said second input means being associated with one of a buy side and sell side of said second traded instrument depending upon user-perceived correlation of movements between said first market and said second market.

12. The computerized trading system for use by traders according to claim 11, wherein said stop direction is a bid with regard to said second trigger instrument, and said stop price being on the bid side of said second market;
said market order of said first traded instrument being a pending order when one of the following is met: said market's best bid price of said second trigger instrument is greater than said stop price, and said market's best bid price of said second trigger instrument is equal to said stop price and said stop quantity order trigger is less than said market's bid quantity at said market's best bid price.

13. The computerized trading system for use by traders according to claim 11, wherein said stop direction is a bid with regard to said second trigger instrument, and said stop price being on the bid side of said second market;
said one limit order of said first traded instrument being a submitted limit order when one of the following is met: said market's best bid price of said second trigger instrument is less than said stop price, and said market's best bid price of said second trigger instrument is equal to said stop price and said stop quantity is one of equal to or greater than said market's bid quantity at said market's best bid price of the second instrument.

14. The computerized trading system for use by traders according to claim 11, wherein said stop direction is an offer with regard to said second trigger instrument, and said stop price being on the offer side of said second market;
said one limit order of said first traded instrument being a pending order when one of the following is met: said market's best offer price of said second trigger instrument is less than said stop price, and said market's best offer price of said second trigger instrument is equal to said stop price and said stop quantity order trigger is less than said market's offer quantity at said market's best offer price.

15. The computerized trading system for use by traders according to claim 11, wherein said stop direction is an offer with regard to said second trigger instrument, and said stop price being on the offer side of said second market;
said one limit order of said first traded instrument being a submitted limit order when one of the following is met: said market's best offer price of said second trigger instrument is greater than said stop price, and said market's best offer price of said second trigger instrument is equal to said stop price and said stop quantity order trigger is one of equal to or greater than said market's offer quantity at said market's best offer price.

16. The computerized trading system for use by traders according to claim 13, wherein said order direction is a limit buy order.

17. The computerized trading system for use by traders according to claim 13, wherein said order direction is a limit sell order.

18. The computerized trading system for use by traders according to claim 15, wherein said order direction is a limit buy order.

19. The computerized trading system for use by traders according to claim 15, wherein said order direction is a limit sell order.

20. A method of trading in a trading instrument using a computerized trading system for use by traders, which computerized trading system is accessible to at least one market for retrieving market data for obtaining market price, bid quantity, and offer quantity of at least one traded instrument for use by a trader in determining buy and sell orders in a traded instrument, comprising:
(a) inputting into the computerized trading system specified input data for type of order, order price, and trade quantity of a limit order for a traded instrument;
(b) said step (a) comprising providing limit price and stop price criteria upon which a market order is based, and providing a stop quantity order trigger;
(c) said step of providing a stop quantity order trigger comprising defining a minimum quantity below which and at which the limit order is submitted, and above which the market order is pending, said minimum quantity representing a quantity of one of a market bid quantity and a market offer quantity of a traded instrument available at the market price; and
(d) transmitting the market order to the market by the computerized trading system for potential execution based on the specified input data of said steps (a) through (c).

21. The method of trading in a trading instrument using a computerized trading system for use by traders according to claim 20, wherein said step (d) is a pending sell order when the market's best bid price is equal to the stop price and the minimum quantity of the stop quantity order trigger is less than said market's bid quantity at said market's best bid price, or when the market's best bid price is greater than the stop price.

22. The method of trading in a trading instrument using a computerized trading system for use by traders according to claim 20, further comprising:
(e) submitting a limit sell order of said step (d) at the market for the traded instrument when one of the market bid price is less than the stop price, and the market bid price is equal to the stop price and the market bid quantity of the traded instrument is one of equal to and less than said specified minimum quantity.

23. The method of trading in a trading instrument using a computerized trading system for use by traders according to claim 20, wherein said step (d) is a pending buy order when the market's best offer price is equal to the stop price and the minimum quantity order trigger is less than the market's offer quantity at the market's best offer price, or when the market's best offer price is less than the stop price.

24. The method of trading in a trading instrument using a computerized trading system for use by traders according to claim 20, further comprising:
(e) submitting a limit buy order of said step (d) at the market for the traded instrument when the market's best offer price is equal to the stop price and the minimum quantity order trigger is greater than or equal to the market's offer quantity at the market's best price.

25. The method of trading in a trading instrument using a computerized trading system for use by traders according to claim 20, wherein:
(e) said step (a) comprises inputting into the computerized trading system specified input data for type of order, order price, and trade quantity of a limit order for a first traded instrument;
(f) said step (e) comprising providing the limit price criterion for the first traded instrument upon which the limit order is based;
(g) said step (b) providing the stop price and stop quantity order trigger criteria for a second traded instrument serving as a trigger instrument for the first traded instrument;
(h) said step of providing a stop quantity order trigger for the second trade instrument of said step (g) comprising defining a minimum quantity below which and at which the limit order for said first traded instrument is submitted, and above which the market order for the first traded instrument is pending, said minimum quantity representing a quantity of one of a market bid quantity and a market offer quantity of said second traded instrument available at the market price; and
(i) said step (d) transmitting the order of said step (e) for said first traded instrument to the market for the first traded instrument by the computerized trading system when said trigger criteria of said step (g) has been met.

26. The method of trading in a trading instrument using a computerized trading system for use by traders according to claim 25, wherein said stop quantity order trigger and said stop price of said step (g) are associated with one of the: bid side of said second instrument and the offer side of said second instrument.

27. The method of trading in a trading instrument using a computerized trading system for use by traders according to claim 26, wherein said limit order of said first traded instrument of said step (i) is a pending order when one of the following is met: said market's best bid price of said second trigger instrument is greater than said stop price, and said market's best bid price of said second trigger instrument is equal to said stop price and said stop quantity order trigger of said second trade instrument is less than said market's bid quantity at said market's best bid price.

28. The method of trading in a trading instrument using a computerized trading system for use by traders according to claim 26, wherein said limit order of said first traded instrument of said step (i) is a submitted order when one of the following is met: said market's best bid price of said second trigger instrument is less than said stop price, and said market's best bid price of said second trigger instrument is equal to said stop price and said stop quantity is one of equal to and greater than said market's bid quantity at said market's best bid price for said second instrument.

29. The method of trading in a trading instrument using a computerized trading system for use by traders according to claim 26, wherein said limit order of said first traded instrument of said step (i) is a pending order when one of the following is met: said market's best offer price of said second trigger instrument is less than said stop price; and said market's best offer price of said second trigger instrument is equal to said stop price and said stop quantity order trigger is greater than or equal to said market's offer quantity at said market's best offer price of said second trade instrument.

30. The method of trading in a trading instrument using a computerized trading system for use by traders according to claim 26, wherein said limit order of said first traded instrument of said step (i) is a submitted order of said first traded instrument when one of the following is met: said market's best offer price of said second trigger instrument is greater than said stop price; and said market's best offer price of said second trigger instrument is equal to said stop price and said stop quantity order trigger is one of equal to and greater than said market's offer quantity at said market's best offer price of said second trade instrument.

31. The method of trading in a trading instrument using a computerized trading system for use by traders according to claim 26, wherein said type of order of said step (e) is one of a: buy order and sell order.

32. A method of trading in a trading instrument by a computerized trading system using a graphical user interface, which computerized trading system is accessible to at least one market for retrieving market data for obtaining market price, bid quantity, and offer quantity of at least one traded instrument for use by a trader in determining buy and sell orders in a traded instrument, comprising:
(a) displaying on the graphical user interface order entry information for one of a buy limit order and a sell limit order;
(b) said step (a) comprising displaying on said graphical user information the limit price and quantity of said one of a buy limit order and a sell limit order;
(c) displaying on said graphical user interface stop price information for the one of a buy limit order and a sell limit order;
(d) displaying on said graphical user interface trigger-type information for indicating a trigger for determining when said limit order is submitted for execution to a market;
(e) said step (d) comprising displaying on said graphical user interface stop order quantity trigger information for serving as a trigger for determining when said limit order is submitted for execution to a market.

33. The method of trading in a trading instrument by a computerized trading system using a graphical user interface according to claim 32, wherein said step (d) comprises displaying on said graphical user interface type of stop order quantity trigger information of one of the: Traded instrument associated with said limit order, and a trigger instrument associates with a market different from the market of said traded instrument.

34. The method of trading in a trading instrument by a computerized trading system using a graphical user interface according to claim 33, wherein said step (e) comprises displaying on said graphical user interface stop order quantity trigger of one of said traded instrument and said trigger instrument.

35. The method of trading in a trading instrument by a computerized trading system using a graphical user interface according to claim 34, wherein said step (d) comprises displaying on said graphical user interface stop direction trigger information of said trigger instrument.

36. The method of trading in a trading instrument by a computerized trading system using a graphical user interface according to claim 35, wherein said step (d) comprises displaying on said graphical user interface information of said trigger instrument.
